(19) United States
(12) Patent Application Publication
(10) Pub. No.: US 2007/0033159 A1
(43) Pub. Date: Feb. 8, 2007

(54) Query plan editor with integrated optimizer

(76) Inventor: Kevin J. Cherkauer, Portland, OR (US)

Correspondence Address: LIEBERMAN & BRANDSDORFER, LLC, 802 STILL CREEK LANE, GAITHERSBURG, MD, 20878, US

(21) Appl. No.: 11/195,957

(22) Filed: Aug. 3, 2005

(51) Int. Cl. G06F 17/30

(52) U.S. Cl. 707/2

(57) ABSTRACT

A tool and method for integrating manual instructions of a database query plan with a database optimizer. The tool may be in the form of an editor to receive manual instructions associated with selection of database objects such as tables and operations associated with the objects. The editor may consult with the database optimizer prior to submitting query plan execution instructions. The consultation may result in the optimizer providing alternatively available selections to the editor and/or a cost estimate for selected operations and/or automatic selection of operators to complete a plan that has been partially constructed or edited manually. Following completion of the query plan, the editor may submit the query plan to the optimizer for execution and/or save the plan for use in future execution(s) of the query.

### BACKGROUND OF THE INVENTION

1. Technical Field

This invention relates to tool and method for modifying a query plan for a database. More specifically, the tool and method adds the capability for manual modification of the query plan, which may be integrated with an optimizer, allowing all or any part of the query plan to be constructed or modified manually.

2. Description of the Prior Art

Modern databases include a program component called an optimizer to select a data access plan to produce a desired result set. The optimizer minimizes the time required to select a plan from among all possible selections, and the time required to execute the selected plan. One of the primary functions of the optimizer is to minimize cost, wherein cost may include time, a weighted sum of estimated CPU time, an estimated number of disk accesses, etc.

A data access plan, also known as a query plan, and hereinafter referred to as a plan, is a set of operations that will be executed to satisfy a query. The plan utilized by the optimizer is often shown as a tree structure having leaf nodes, intermediate nodes, and a root node. The query is a question about data in a database that will produce an answer that will consist of a subset of data in the database. The leaf nodes of the tree are database objects, such as tables, views, indexes, etc., and contain data. The leaf nodes of the tree contain the data needed to compute a result of a query. The intermediate nodes in the tree structure represents computational operations that are applied to rows obtained from the leaf nodes or earlier operations. A computational operation produces a set of output data rows which are forwarded to an associated parent node. The root node of the tree structure is the final operation of the plan and produces the final set of result rows. Typically, the tree structure is built from the bottom up with the optimizer selecting operations at each point from a selection of operations available.

FIG. 1 is a prior art block diagram (10) of a sample partial tree structure with three leaf nodes (12), (14), and (16). In this example, each node (12), (14), and (16) represents a table in a database. The query illustrated in this example is a join operation among the three tables. A join operation matches records in two tables of the database. In the example shown in FIG. 1, there are two categories of join operations available, Nested Loop and Hash Join. The quantity and categories of join operations in the example shown in FIG. 1 are merely an illustrative quantity. The system may be enlarged to include additional tables and categories of operations, and similarly, the system may be reduced to include fewer tables and categories of operations. As such, the tables and operations shown in FIG. 1 are not to be construed as a limiting factor.

The query has to select the order to perform the joins among the tables, and the category of join to select for each operation. In this example, the optimizer has the following six operations to choose from when building the first intermediate node above the leaf nodes: Nested Loop join of (12) and (14), Nested Loop join of (12) and (16), Nested Loop join of (14) and (16), Hash Join of (12) and (14), Hash Join of (12) and (16), and Hash Join of (14) and (16). Once a decision is made for the first operation, this reduces the number of remaining operations. The number of plans that can satisfy a given query increases exponentially with the number of operations needed to transform data inputs into a desired result set. The example shown in FIG. 1 is limited to three tables. However, it is not feasible for the optimizer to evaluate every possible plan, or even a large proportion of possible plans for a query that utilizes a large quantity of tables. The optimizer is thus forced to choose plans heuristically, which may lead it to select a plan that is much more costly than the best plan. FIG. 2 is a prior art block diagram (20) of a sample partial tree from FIG. 1 after a Nested Loop join of leaf nodes (12) and (14) has been selected. As shown, there is a new node (18), representing the join operation of nodes (12) and (14). Based upon the two categories of join operations available in this example, the optimizer has the following operations to choose from: Nested Loop join of (18) and (16), and Hash Join of (18) and (16). FIG. 3 is a prior art block diagram (30) of a 10 sample tree from FIGS. 1 and 2, based upon selection of a hash join operation of (18) and (16) from FIG. 2. As shown, there is a new node (22), representing the join operation of nodes (18) and (16). In this example, node (22) represents a Hash Join operation of nodes (18) and (16).

There are two prior art solutions for supporting the optimizer making an intelligent selection of operations. In one prior art solution, the optimizer uses statistics that database has collected regarding the data involved in a query to estimate the cost of each choice. One or more plans are then constructed by the optimizer using heuristic algorithms whose goal is to minimize cost. However, since the algorithms for invoking the plans are heuristic and the search space is generally large, the entire set of plans can never be explored. The optimizer will select the plan. It is likely that the optimizer may select a query that has a high cost when executed on the actual database system. In another prior art solution, a user can influence the optimizer. Examples of user influence (often called “hints”) include: manually changing statistics the optimizer uses when estimating the cost of an operation, recommending selection of an index scan in place of a full table scan, and manually changing weights used in the optimizer's definition of cost. However, user influence of an optimizer does not enable a user to take complete control of development of the plan. Limitations of user influence of the optimizer include lack of specificity and precision supported by the optimizer to accept influence. Accordingly, the prior art for influencing the optimizer does not assure such influence will actually change one or more operations of a plan, always change operations in the way the user intends, or avoid changing the plans for other queries the user does not intend to change.

Therefore there is a need to allow a user, in the form of a database administrator or support personnel, to directly specify all or portions of a plan.

### SUMMARY OF THE INVENTION

This invention comprises a tool and method for manually directing a database query plan.

In one aspect, a database system is provided with an optimizer and an editor. The editor is in communication with the optimizer. The editor receives manual instruction to create a query plan and to communicate the manual instruction to the optimizer. In response to receipt of the manual instruction, the editor receives a selection of available objects and operations from the optimizer.

In another aspect of the invention, a method is provided for creating a query plan for a database. Manual instructions for creation of a query plan are integrated with a database optimizer. A selection of available operations and associated cost estimate for each available operation is communicated from the optimizer. The query plan is completed for execution based upon communication of the available operations.

In yet another aspect of the invention, a computer program product is provided with a computer useable medium having computer useable program code for creating a query plan for a database. The computer program product includes computer useable program code for integrating instructions received for creation of the query plan for execution with an optimizer. The program code integrates the instructions with a database optimizer. In addition, program code is provided both for communicating a selection of available operations and associated cost estimate for each available operation from the optimizer, and completing the query plan for execution based upon communication of the available operations.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a block diagram of a prior art partial plan structure.

FIG. 2 is a block diagram of a prior art plan partial structure illustrating one join operation.

FIG. 3 is a block diagram of a prior art completed plan structure illustrating two join operations.

FIGS. 4a, 4b, and 4c are flow charts illustrating the process of developing a database query for submission for execution according to the preferred embodiment of this invention, and is suggested for printing on the first page of the issued patent.

FIG. 5 is a block diagram of a partial plan structure with a cost estimate field.

FIG. 6 is a block diagram of a partial plan structure illustrating one join operation and the associated cost estimate field.

FIG. 7 is a block diagram of a partial plan structure illustrating an alternative join operation to that shown in FIG. 6, and the associated cost estimate field.

FIG. 8 is a block diagram of a completed plan structure illustrating two join operations and the associated cost estimate field.

FIG. 9 is a block diagram illustrating the plan tool in communication with the database optimizer.

FIG. 10 is a block diagram illustrating a client machine for use in the system showing components of the plan tool.

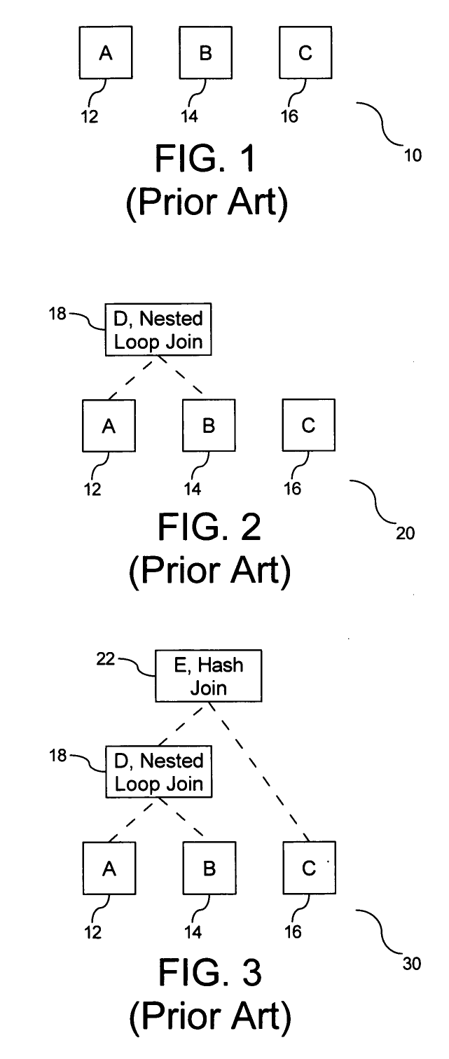

### DESCRIPTION OF THE PREFERRED EMBODIMENT

### Overview

A tool is provided to support partial or complete manual development of a database query plan. The tool supports manual selection of plan operators for a query in conjunction with communication with an associated database optimizer. Each operation available among the selected tables includes a cost estimate provided by the optimizer and communicated to the editor. At any time during the plan development, the tool supports intervention by a database optimizer to partially or completely complete formulation of the plan. Similarly, at any time the plan is being edited manually, each operation previously selected manually or by the optimizer may be manually modified to an alternately available operation, or deleted along with its dependent operators.

### Technical Details

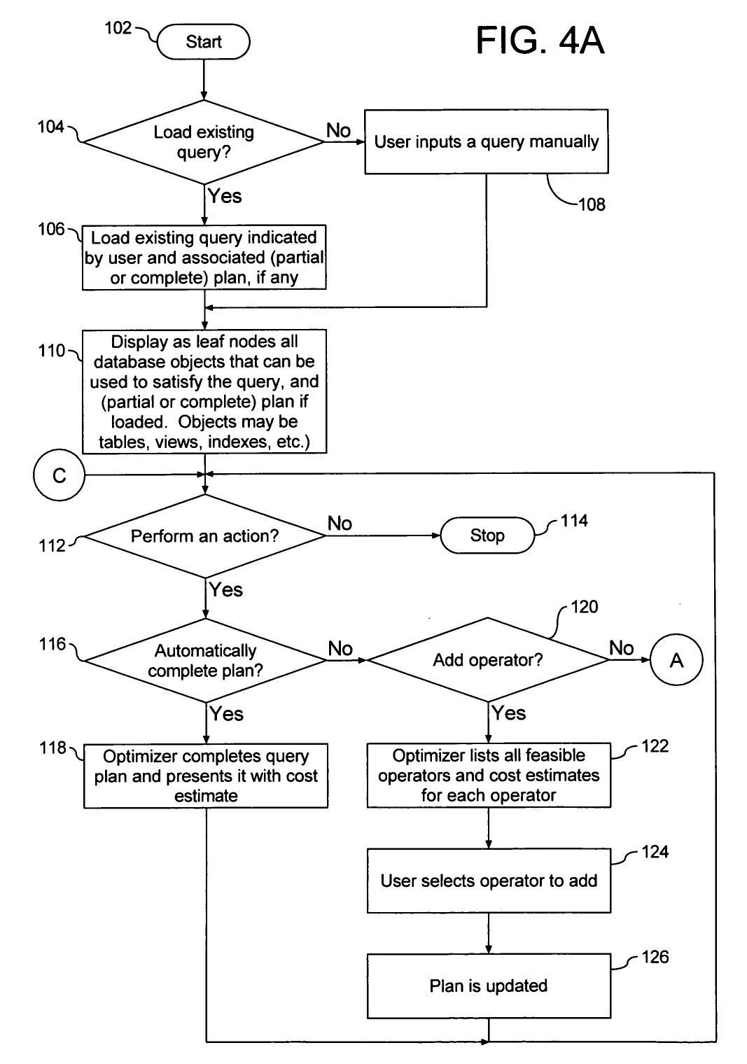

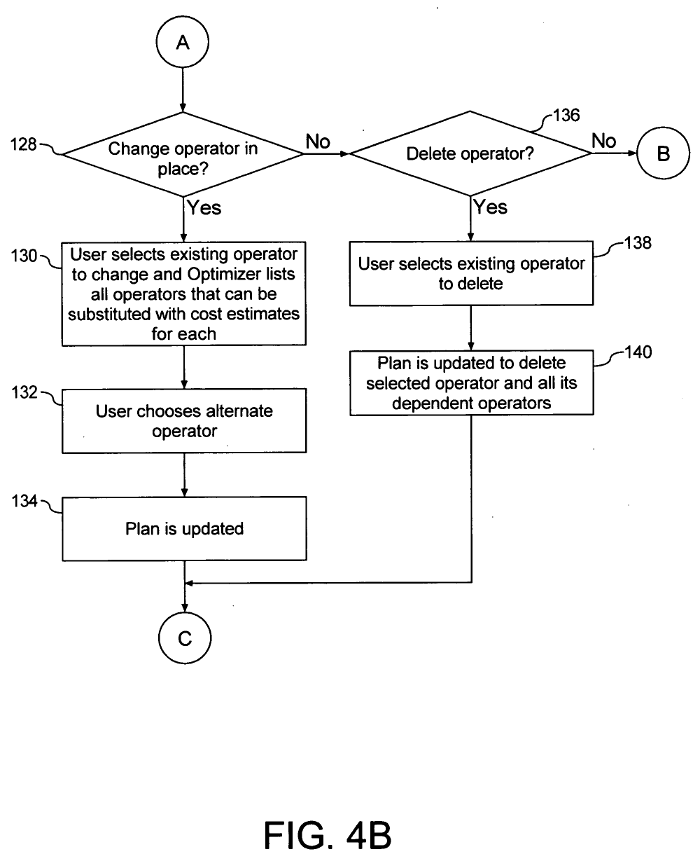

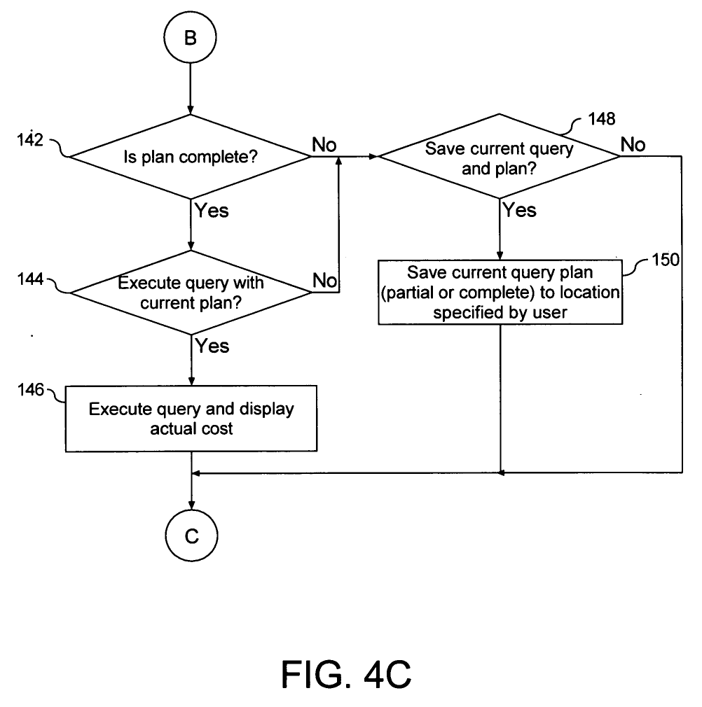

FIG. 4 is a flow chart (100) illustrating the process of developing a database plan.

Following start (102) of the process, a test is conducted to determine if an existing query is being loaded (104). A positive response to the test at step (104) will result in loading an existing query as indicated by a user (106). Examples of an existing query include a partial or complete query saved in storage media from a prior session. The test at step (104) provides the user with an option to load a query that exists, such as a partial query saved from a prior session, or to create a new query. The existing query may have an associated partial or complete plan, which is loaded with it. A negative response to the test at step (104) will result in a user manually inputting a query (108). Following steps (106) or (108), each database object (table, view, index, etc.) that can be used to satisfy the query is displayed, along with a list of all feasible operations that can be applied to these objects to make progress toward satisfying the query in conjunction with a cost estimate for each available operation (110). The cost estimate is provided by the optimizer and reflects an estimated cost for individual selection of each of the listed operations available. Following the query display at step (110), a test is conducted to determine if the user wants to perform any actions, which may include making changes to the plan or executing a completed plan (112). A positive response to the test at step (112) will follow with a series of tests to determine how the user wants to change the plan, or if the user wants the optimizer to complete development of the plan or execute a completed plan. A negative response to the test at step (112) is an indication that the user does not wish to perform any more actions involving this plan, causing the process to terminate (114). A positive response to the test at step (112) will follow with a choice of allowing automated completion of the plan by the optimizer (116). A positive response to the test at step (116) will allow the optimizer to complete the plan and to present the complete plan to the user with a cost estimate for execution of the plan (118), followed by a return to step (112). A negative response to the test at step (116) will follow with one or more tests to determine how the user wants to change the plan or execute a completed plan.

The following steps outline how the user can select to manually edit the plan. Following a negative response to the test at step (116), a subsequent test is conducted to determine if the user wants to add an operator to the plan (120). A positive response to the test at step (120) will result in the optimizer presenting a list of all feasible operators along with a cost estimate for selection of each individual operator (122). The user may then select an operator to add to the plan (124). Following the selection at step (124), the plan is updated (126) and the process returns to step (112). A negative response to the test at step (120) will result in a test to determine if the user wants to change an existing operator in the plan (128). A positive response to the test at step (128) will result in the user selecting an existing operator in the plan and the optimizer presenting a list of all operators that can be substituted for the user selected operator (130). Each operator presented by the optimizer at step (130) will include a cost estimate as calculated by the optimizer. Following the selection at step (130), the user selects one of the operators presented by the optimizer (132), the plan is then updated (134), and the process returns to step (112). If the response to the test at step (128) is negative, a subsequent test is conducted to determine if the user wants to remove an operator in the existing configuration of the plan (136). A positive response to the test at step (136) will result in the user selecting one of the operators in the plan for removal (138), which automatically deletes all operators that depend, directly or indirectly, on the deleted operators outputs. Thereafter, the plan is updated (140) to reflect the changes made at step (138), including removal of all operators dependent on the operator selected for removal, and the process returns to step (112). A negative response to the test at step (136) will result in a test to determine if the plan is complete (142). If the user does not select to delete an operator at step (142), the user is provided an option to execute the plan in its current incarnation (144). A positive response to the test at step (144) results in execution of the plan and a display of the actual cost to the user (146), followed by a return to step (112). The process returns to step (112) to determine if the user is satisfied with the actual cost of execution of the query as compared to the estimated cost as provided by the optimizer prior to execution of the query. Upon return to step (112) following execution, the user can decide is they are satisfied with the query execution and proceed to step (114), or if they are not satisfied, the user can proceed to further edit the plan. A negative response to the tests at steps (142) or (144) results in a test to determine if the user wants to save the current plan (148). A positive response to the test at step (148) results in saving the current plan to storage media as specified by the user (150). The saved plan may be a partial or complete plan. Following step (150) or a negative response to the test at step (148), the process returns to step (112). Accordingly, the plan may be partially or completely developed in a manual or automated manner.

The following four diagrams illustrate the creation and/or editing of a query plan as outlined in FIG. 4 above for a sample query written in SQL (Structured Query Language). In this example, the sample query joins data from three database objects. Database objects can be tables, views, indexes, or any other object from which the database can retrieve data to satisfy a query. FIG. 5 is a block diagram (200) showing three nodes (202), (204), and (206), with each node representing one of the database objects needed to satisfy the query. It should also be noted, that all alternative objects that can be used to satisfy the query, as determined by the optimizer, will be shown in the display. In addition, a total estimated cost field (208) is provided to illustrate the optimizer's projected cost for execution of an associated query plan. As shown herein, there are no operations selected for any of the nodes, and the estimated cost for execution is set at zero. If the user elects to create a plan with the three illustrated nodes, a list of feasible operators is presented, with each operator having an associated cost estimate as provided by the optimizer.

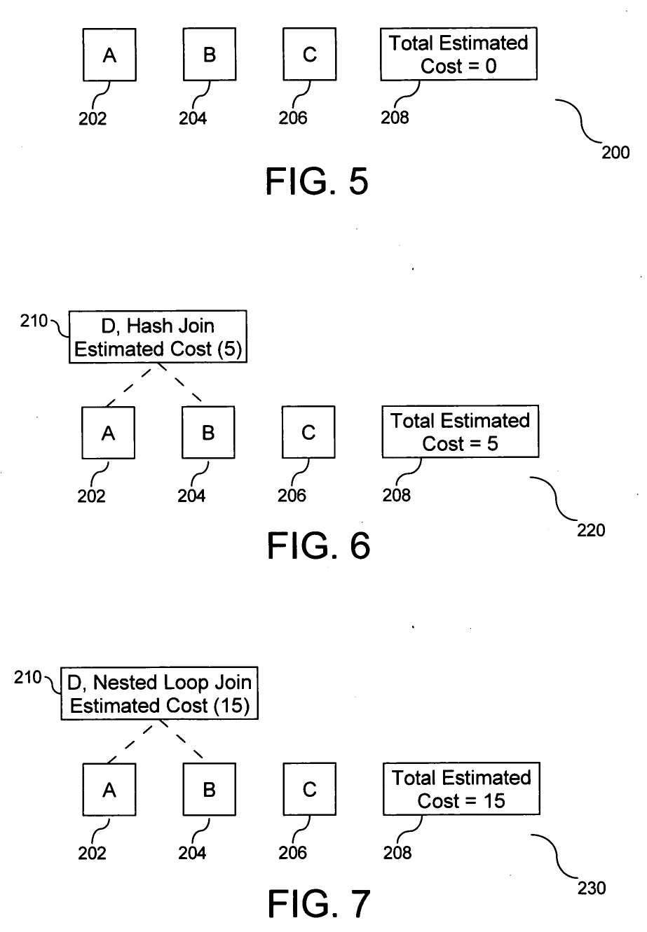

FIG. 6 is a block diagram (220) showing the three nodes (202), (204), and (206), with an additional node (210) created as a result of selection of a hash join operation for nodes (202) and (204). The additional node (210) is known as an operator node as it represents an operator to satisfy part of the plan. As shown, the additional node (210) includes a label having the operator name and estimated cost for the operation. In one embodiment, each operator node will include a label showing the name of the operator and the estimated cost. Similarly, a filter may be included to limit the data displayed in the label. In addition, the total cost estimate field (208) is changed to reflect the cost associated with the selected operation, as this is the only operation selected at this stage.

Since there is an operation present in the plan, the user now has an option available to edit the plan by selecting an alternate operation at node (210). FIG. 7 is a block diagram (230) showing the original three nodes (202), (204), and (206) with an additional operator node (210) created by an amended nested loop join operation on nodes (202) and (204). The cost estimate field (208) is changed to reflect the costs associated with the amended operation, as this is the only operation selected at this stage.

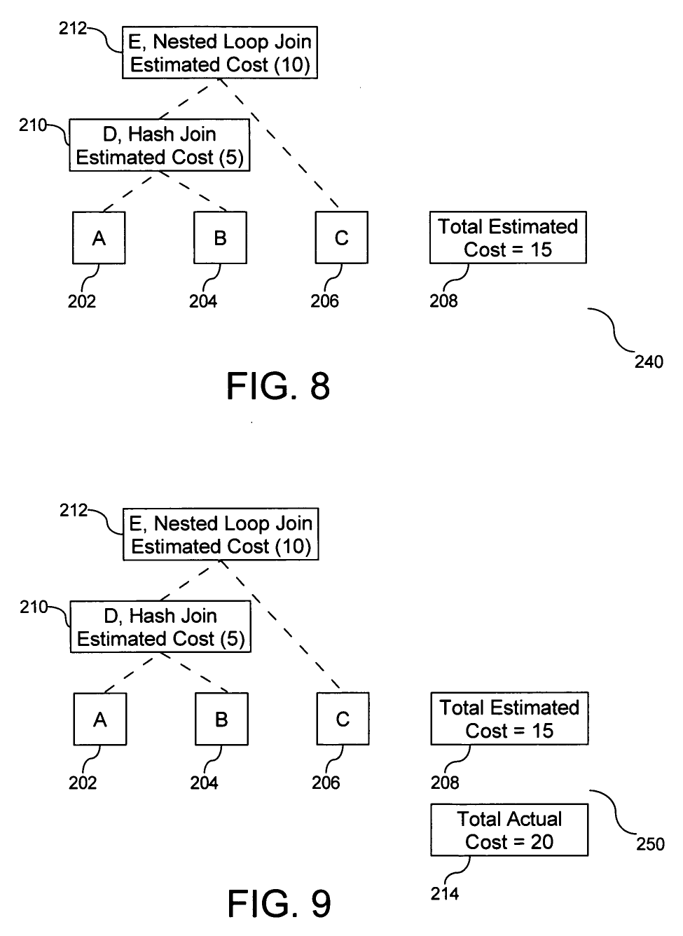

As noted above, the block diagrams of FIGS. 5, 6, and 7 each have three nodes (202), (204), and (206), with each node reflecting an object in the database selected for use in a plan. The plan is not complete until all operations needed to satisfy the query have been included in the plan. For the example shown in FIGS. 5, 6, and 7, the plan must include two join operations to achieve joining all three object represented herein as nodes in a tree. FIG. 8 is a block diagram (240) showing the three original nodes (202), (204), (206), a hash join operator node (210), and a new operator node (212) created as a result of selection of a nested loop join operation for nodes (210) and (206). In addition, the cost estimate field (208) is changed to reflect the sum of the costs associated with the first operation joining nodes (202) and (204), and the second operation joining node (210) and (206). As shown, the two join operations selected accomplish the joining of all three objects, and the plan is complete and ready for execution. FIG. 9 is a block diagram (250) showing each of the nodes (202), (204), (206), (210), and (212), the total cost estimate field (208) and an actual cost field (214). The actual cost field (214) is displayed after the user causes the query to be executed with the current plan incarnation. In this example, it is shown that the actual cost of executing the query is greater than the cost estimated by the optimizer. The user has the option to edit the plan by selecting node (210) and/or node (212) and changing to an alternate operation that applies to the same number and type of inputs as the selected node, if one is available. For example, nodes (210) and (212) can both be edited, but each one of these operators can only be replaced with an operator that accepts two inputs and yields one output. A change of an operation may change the cost estimated by the optimizer and/or the actual cost of execution. The user may also delete an operation from the plan, which will in turn delete all ancestor operations, i.e. operations higher in the tree, that depend on that operation. This enables the user to restructure part or all of the plan.

In one embodiment, the process and tool for creating and/or amending a plan may include a graphical user interface for communicating with a user activated edit tool, also known as an editor. Preferably, the editor will include a menu or button for loading and saving input queries along with their associated partial or complete plans. The interface would also include buttons and pull down menus illustrating options available to the user at each stage in the creation and/or editing of the plan. For example, there may be an Add New Operator button, which would produce a list of all feasible operators available for different tables in the query. Each of the displayed operators would include an estimated cost of execution, as provided by the optimizer. In addition, there may be an Automatically Complete Plan button, which would be available for selection when the plan is not complete. Selection of this button would instruct the optimizer to complete the plan and to present it to the user prior to execution. Once the plan is complete, a Run Query With Current Plan button is available to execute the plan. In addition, there may be a context menu available for each operator in a partial or full plan. This menu may allow the user to replace the operator with another one that applies to the same number and types of input and outputs, if one is available. The context menu may also allow the user to delete the operator from the plan, along with all ancestor operators that depend on the deleted operator. Additionally, there may be a menu allowing the user to change optimizer settings, such as the optimization level to be used, which will affect the construction of any part of the plan that the user chooses to have the optimizer generate automatically. For example, the optimization level may control the amount of searching the optimizer does for a plan. Each of the buttons and menus discussed herein would only be available for selection and activation by the edit tool when appropriate. For example, the Run Query With Current Plan would not be available with an incomplete plan. In one embodiment, the graphical user interface may present the plan created by the user and/or optimizer in a tree structure as shown in FIGS. 5-9. However, the interface should not be limited to a graphical user interface with the buttons, menus, and/or display as described herein. The interface may take on other forms that support and facilitate communication between the optimizer and the user.

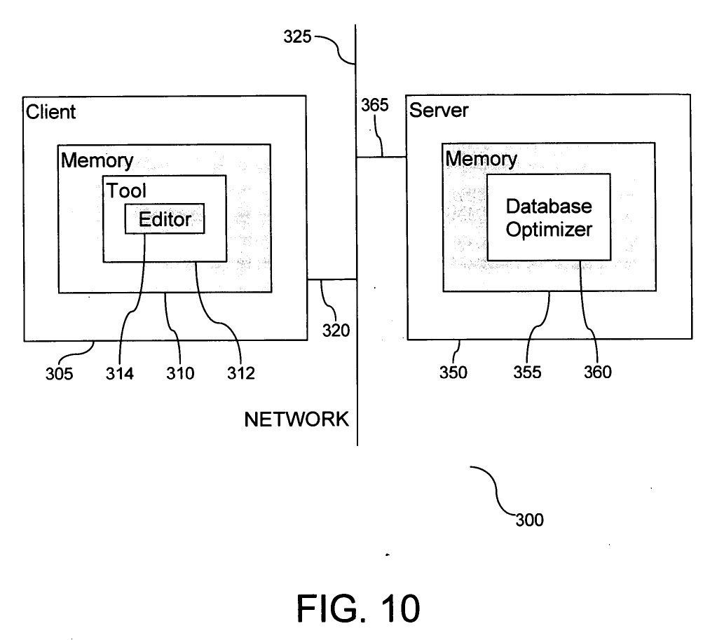

The method for creating and/or editing a plan for submission to a database optimizer may be invoked in the form of a tool utilized by a client machine. FIG. 10 is a block diagram (300) of a client machine (305) for use in the system showing components of the plan tool. As shown, the client machine (305) includes memory (310) having a database communication tool (312) embedded therein. The tool (312) may include an editor (314). The client machine (305) is in communication with a server (350) across a network (325) through a network connection (320). The server (350) includes memory (355) having a database optimizer component (360). The server (350) is in communication with the client (305) across the network (325) through a network connection (365). The optimizer (360) is responsive to instructions received by the editor (314) through the database communication tool (312) in the client machine (305). The optimizer (360) is set to facilitate creation of a database plan in response to a plan request from a client.

In one embodiment, the database communication tool (312) and the optimizer component (360) may be software components stored on a computer-readable medium as it contains data in a machine readable format. For the purposes of this description, a computer-useable, computer-readable, and machine readable medium or format can be any apparatus that can contain, store, communicate, propagate, or transport the program for use by or in connection with the instruction execution system, apparatus, or device. Accordingly, the database communication tool and optimizer component may all be in the form of hardware elements in the computer system or software elements in a computer-readable format or a combination of software and hardware.

### Advantages Over The Prior Art

The tool and process for creating and/or editing a plan enables a user to become proactive and independent in formulating a plan. This tool enables the user to directly edit a plan, or to construct a new plan from scratch. The edit operations include the ability to add a new operator, change an existing operator, remove an existing operator, and instructing the optimizer to complete an uncompleted plan. For an uncompleted plan, the tool provides a list of all operations available to be added to the plan, as communicated by the optimizer. The manual plan editing capability is integrated with the optimizer so that only valid choices are presented to the user as options, cost estimates for all choices are provided to the user by the optimizer, and the user can invoke the optimizer to fill in the remainder of a plan that has partially been constructed manually.

### Alternative Embodiments

It will be appreciated that, although specific embodiments of the invention have been described herein for purposes of illustration, various modifications may be made without departing from the spirit and scope of the invention. In particular, the tool for editing the plan may be an ancillary device that is in communication with the database optimizer. In addition, steps (116), (120), (128), (136), (142), and (148) are not restricted to the order illustrated in FIG. 4. Accordingly, the scope of protection of this invention is limited only by the following claims and their equivalents.

We claim:

1. A database system comprising:
an optimizer; and
an editor in communication with said optimizer;
said editor adapted to receive a manual instruction to create a query plan and to communicate said manual instruction to said optimizer, wherein said editor is adapted to receive a selection of available objects and operations from said optimizer, in response to receipt of said manual instruction.

2. The tool of claim 1, further comprising an execution instruction adapted to be submitted to said optimizer for execution of a completed query plan.

3. The tool of claim 1, wherein an operation provided by said optimizer may be directly substituted in place of a current operation.

4. The tool of claim 3, wherein substitution of an operation may change a structure of said plan.

5. The tool of claim 1, further comprising a communication device adapted to display construction of said query plan to said user.

6. The tool of claim 1, further comprising a cost estimate for each available operation adapted to be communicated from said optimizer.

7. The tool of claim 1, wherein said plan is selected from a group consisting of: a complete plan, a partially constructed plan, a prior plan, and combinations thereof.

8. A method for creating a query plan for a database, comprising:
integrating manual instructions for creating said query plan for execution with a database optimizer;
communicating a selection of available operations and associated cost estimate for each available operation from said optimizer; and
completing said query plan for execution based upon said selection of available operations.

9. The method of claim 8, further comprising selecting an operation communicated by said optimizer in place of previously selected operation.

10. The method of claim 9, wherein the step of selecting an operation may change a structure of said plan.

11. The method of claim 8, further comprising displaying construction of said query plan.

12. The method of claim 8, wherein said plan is selected from a group consisting of: a complete plan, a partially constructed plan, a prior plan, and combinations thereof.

13. The method of claim 8, wherein the step of completing said query plan is selected from a group consisting of: manual and automated.

14. A computer program product comprising:
a computer useable medium having computer useable program code for creating a query plan for a database, said computer program product including:
computer useable program code for integrating instructions received for creating said query plan for execution with a database optimizer;
computer useable program code for communicating a selection of available operations and associated cost estimate for each available operation from said optimizer; and
computer useable program code for completing said query plan for execution based upon communication of said available operations.

15. The computer program product of claim 14, wherein said computer useable program code for completing said query plan includes code for substituting an operation communicated by said optimizer in place of previously selected operation.

16. The computer program product of claim 15, wherein said computer code for substituting an operation may change a structure of said plan.

17. The computer program product of claim 14, further comprising computer program code for displaying construction of said query plan.

18. The computer program product of claim 14, wherein said plan is selected from a group consisting of: a complete plan, a partially constructed plan, a prior plan, and combinations thereof.

19. The computer program product of claim 14, wherein said computer useable code for completing said query is selected from a group consisting of: manual and automated.

20. The computer program product of claim 14, further comprising computer program code for submission to said optimizer for execution of a completed query plan.
